(19) United States
(12) Patent Application Publication
(10) Pub. No.: US 2005/0108269 A1
(43) Pub. Date: May 19, 2005

(54) Device for storing data and method for dividing space for data storing

(76) Inventors: Andrzej Szajdecki, Zielona Gora (PL); Adam Biniszkiewicz, Zielona Gora (PL)

Correspondence Address: HOFFMANN & BARON, LLP, 6900 JERICHO TURNPIKE, SYOSSET, NY, 11791, US

(21) Appl. No.: 10/501,116

(22) PCT Filed: Jan. 16, 2003
(86) PCT No.: PCT/PL03/00004

(30) Foreign Application Priority Data
Jan. 18, 2002 (PL) P-351779

(51) Int. Cl. G06F 17/00

(52) U.S. Cl. 707/102

(57) ABSTRACT

A device for data storing with logically separated areas has blocks (2, 3, 4) of a predetermined size created from a definite number of logically separated smallest areas (1). Larger blocks (3, 4) with a higher integration level are definite multiples of smaller blocks (2, 3) with a lower integration level, and the smaller blocks (2, 3) compose the larger blocks (3, 4) larger by one integration level, and integration of the logically separated smallest areas (1) is performed in recurrent manner till the integration covers the whole area of the device for data storing.

### TECHNICAL FIELD

The invention relates to a device for storing information with logically separated areas and a method for dividing space for data storing.

### BACKGROUND ART

The most common devices for storing data are hard disks and floppy disks utilizing different methods of data recording which have different locations within the storage area and different means of access. Space for storing data on the same hard disks can be organized in different ways, and even the organization within one hard disk can be arranged in various ways. The recorded information is usually not a continuous sequence of bytes but is organized in so-called sectors, which are the smallest portions of information that can be read from the disk. Sectors can be assembled into clusters, which are assigned specific numbers.

In the well-known structure of space for data storage described above, both sectors and clusters create a logical structure on the hard disk which can be divided into logical areas, administrated separately, similarly as separate logical disks drives. Most often the partitioning of disks is executed prior to recording any information on them.

From the U.S. Pat. No. 6,032,161 a partition system is known, which is added to an existing partition by creating a new file in the mass memory of the existing partition, and assigning this file the attributes of a partition.

Disks with file systems described above, because of their universality, can be read by any personal computer with a proper operating system and, additionally, are intended to operate medium size files. However, their demand for memory is large and they are not efficient at handling a lot of audio-video data streams of very large size.

### DISCLOSURE OF INVENTION

According to the present invention, a device for data storing with logically separated areas, a definite number of logically separated smallest areas create blocks of a predetermined size, among which larger blocks with a higher integration level are definite multiples of smaller blocks with a lower integration level, and the smaller blocks compose the larger blocks larger by one integration level, and the integration of the logically separated smallest areas is performed in recurrent manner till the integration covers the whole area of the device for data storing.

The size of a block with greater, by one, integration level can have the memory size equal to a multiple of the size of blocks with smaller, by one, integration level, and the amount of information that can be stored in the logically separated smallest area.

The number of the logically separated smallest areas in the block of the minimal integration level can equal the number of bits that can be stored in the logically separated smallest area.

The blocks of predetermined size can have at least three states and information concerning their state is stored within their area or within the area of blocks with greater, by one, integration level.

The blocks of predetermined size may be free, busy or fragmented.

The logically separated smallest areas have at least two states.

The logically separated smallest areas are either free or busy.

The logically separated smallest areas are the smallest areas of memory, which cannot be subdivided, or their multiplication, and their size depends upon the device for storing data.

The logically separated smallest areas have the size of 512 bits.

The blocks of predetermined size do not contain data concerning their state if they are completely busy or free and in that case the related information is included in a greater block with the integration level greater by one.

The object of the invention is also a method for dividing space for data storing with logically separated areas, in which blocks of predetermined size are created from a defined number of logically separated smallest areas, and smaller blocks are combined recurrently into greater blocks till the partition covers the entire area of a device for storing data, where the greater blocks with a higher level of combination are a definite multiplication of the smaller blocks with a lower level of combination, and the smaller blocks are incorporated into the blocks greater by one level than the smaller blocks.

### BRIEF DESCRIPTION OF DRAWINGS

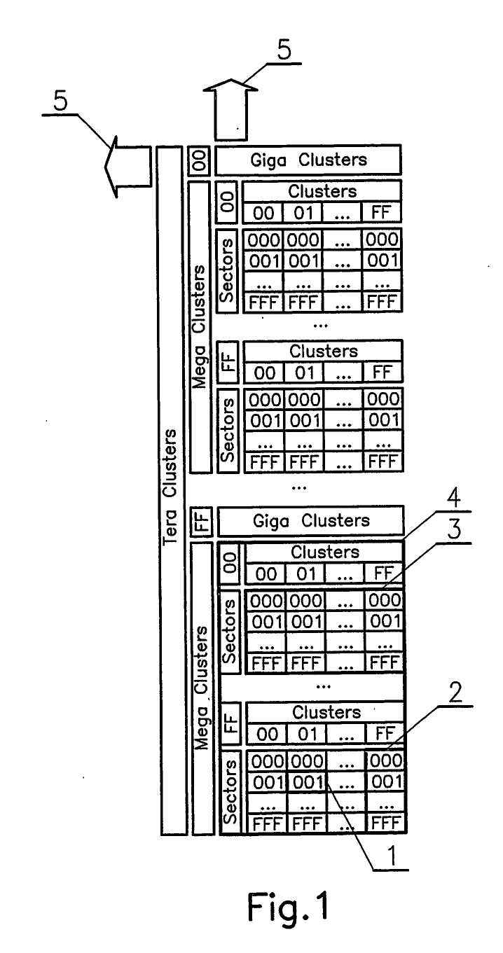

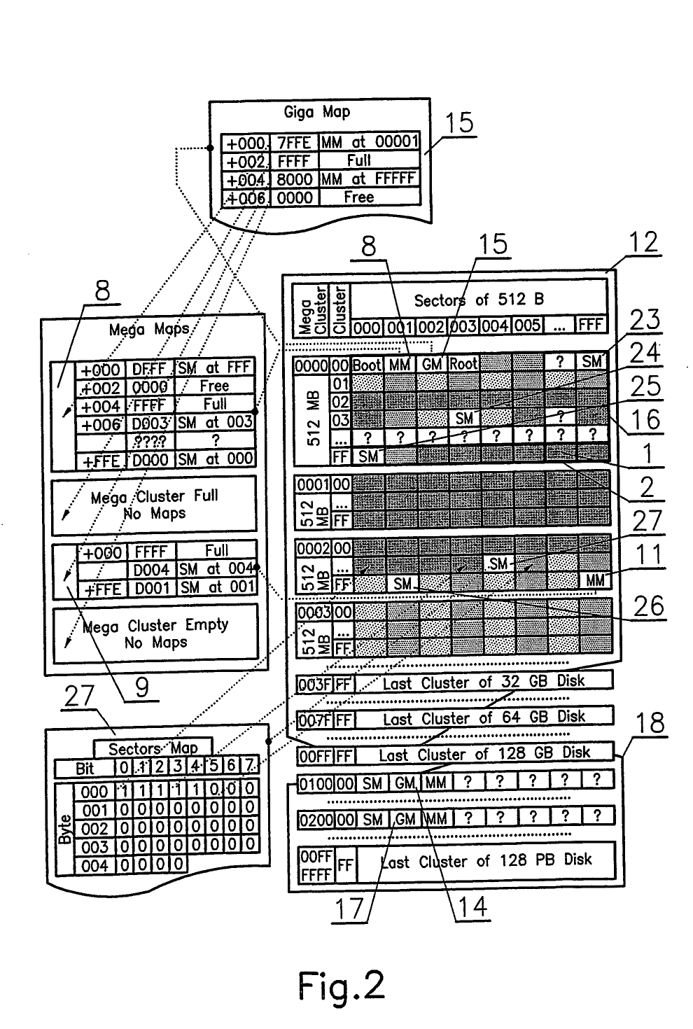

The object of this invention is shown in implementation examples on the enclosed drawings, where FIG. 1 shows a hard disk with logical partitioning executed and FIG. 2 shows a hard disk with maps.

### BEST MODE FOR CARRYING OUT THE INVENTION

The invention will be described in detail with reference to a hard disk but the presented solution can be applied to other devices for storing data.

The hard disk shown in FIG. 1 contains logically separated areas. Its smallest allocation unit or, in other words, its logically separated smallest area, is a sector 1. The greatest logically separated areas of that disk are blocks of memory called teraclusters, which are divided into smaller areas, 256 GB in size, called gigaclusters 4. The gigaclusters 4 are divided into megaclusters 3, which subsequently are divided into clusters 2. The process of hard disk division is performed recurrently till the blocks of the smallest logically separated areas, called the sectors 1, are reached.

The arrows 5 mean that a teracluster can form a bigger area unit whose upper limit is not determined.

The teracluster of the described hard disk has 256 gigaclusters 4 numbered from 0×00 to 0×FF in the hexadecimal system. Each gigacluster 4 has 256 megaclusters 3, each with 256 clusters 2 having 4096 sectors 1 of the 512 bytes capacity. In consequence, a definite number of blocks with a smaller size and with a lower level of integration, for example clusters or megaclusters, compose blocks of a subsequently higher degree of intergration which are megaclusters and gigaclusters, respectively.

The megaclusters 3 and the clusters 2 are numbered in the same way as the gigaclusters 4.

FIG. 2 presents a detailed division of the hard disk with the gigacluster 12 as the greatest area unit. The fragment of this hard disk, containing 4096 sectors 1, creates the cluster 2 of the size of 2 MB. Information concerning each sector 1 in the cluster 2 is included into the sectors map 25 placed within the area of the particular cluster 2 and occupying the area of one sector. Every bit of the sectors map 23, 24, 25, 26, 27 shows whether a given sector is busy or free.

In case of a completely busy or free cluster, there is no need to store information within the cluster about its free or busy sectors. Therefore, suitable information is placed in the map of clusters, called the megamap 8, 9, 11. The megamap 8, 9, 11 describes fragmented allocations of the gigacluster 12 and its position is determined in the map of megaclusters, called the gigamap 15. For example, the megamap 8 states that the zero cluster has its sectors map 23 placed in sector 4095, which corresponds to 0×FFF in the hexadecimal system. The subsequent cluster, according to the presented description the first cluster of the megacluster 16, is free. The next one is occupied by one big file and there is no map of sectors. The following cluster has its sectors map in the third sector 24 and the sectors map 25 of the last cluster of the megacluster 16 is located in the zero sector of the cluster.

The gigacluster represents the maximum hard disk size as specified in the ATA/ATAPI-5 standard. For disks smaller than 128 GB, gigaclusters are not fully used and areas greater than the disk size are marked as busy. Disks greater than 128 GB contain more gigaclusters 18. The allocation map of the gigacluster, called the gigamap, 14, 15, 17, is situated in a single sector within the area of the first or last 32767 sectors of the given gigacluster. The gigacluster 12, 18 consists of 256 megaclusters positioned on the gigamap 14, 15, 17. Two bytes of the gigamap describe the state of a particular megacluster and 0×0000 means that the megacluster is free and its map does not exist, 0×7FFF . . . 0×0001 means that a given megacluster is fragmented and its megamap is stored in sector 0×00000 . . . 0×07FFE of this gigacluster, and 0×7FFF . . . 0×0001 means that a given megacluster is fragmented and its megamap is stored in sector 0×F8001 . . . 0×FFFFF of this gigacluster.

A fully busy megacluster may not have its own map and information about the megacluster occupation state is given on the map higher by one degree in the hierarchy, in this case on the gigamap. A totally busy megacluster is marked as 0×FFFF.

A certain regularity can be noted in the quoted description, namely, the final address of the described sector or block originates from the address of the analyzed map and its contents.

The gigamap 15 of a fragment of the disk shown in FIG. 2, is placed in the second sector of the disk and that place is selected arbitrarily for storage of the gigamap 15, however, there is a possibility of choosing different locations. For disks larger than 128 GB, containing more gigaclusters 18, the localization of a gigamap would be determined in a teramap, stored in an arbitrarily selected place on the disk, known in advance, which gives prospects for possible extension of the presented idea. Data stored in the gigamap 15 means that the megamap 8 for a zero megacluster is located in the first sector, and the next megacluster is fully busy. The megacluster 9 is partly fragmented and its megamap is placed in the last sector 11 of that megacluster which is the sector 0×FFFFF of that cluster. The next megacluster is totally free and contains no map.

The map of sectors described above, and a megamap, a gigamap and a teramap, each placed one level higher in the hierarchy, provide information about the state of the logically separated areas described by them, called the blocks.

There are also the boot and root sectors marked in FIG. 2. Their location is set, similarly as for the gigamap in the case of disks not larger than 128 GB, during formatting, possibly in one of the first sectors of that disk. These sectors serve for storing basic information necessary for correct system performance and storage of the structure of directories and files on the disk. For example they define the location of the main directory or the location of gigamap storage.

1. A device for data storing with logically separated areas comprising blocks (2, 3, 4) of a predetermined size created from a definite number of logically separated smallest areas (1), wherein larger blocks (3, 4) with a higher integration level are definite multiples of smaller blocks (2, 3) with a lower integration level, and the smaller blocks (2, 3) compose the larger blocks (3, 4) larger by one integration level, and integration of the logically separated smallest areas (1) is performed in recurrent manner till the integration covers the whole area of the device for data storing.

2. The device for data storing, according to claim 1, wherein a block (3, 4) with greater, by one, integration level has a memory size equal to a multiple of a size of blocks (2, 3) with smaller, by one, integration level, and the amount of information that is stored in the logically separated smallest area (1).

3. The device for data storing, according to claim 1, wherein a number of the logically separated smallest areas (1) in a block (2) of the minimal integration level is equal a number of bits that can be stored in the logically separated smallest area (1).

4. The device for data storing, according to claim 1, wherein blocks (2, 3, 4) of predetermined size have at least three states and information concerning their state is stored within their area or within the area of blocks with greater, by one, integration level.

5. The device for data storing, according to claim 1, wherein blocks (2, 3, 4) of predetermined size may be free, busy or fragmented.

6. The device for data storing, according to claim 1, wherein the logically separated smallest areas (1) have at least two states.

7. The device for data storing, according to claim 1, wherein the logically separated smallest areas (1) are either free or busy.

8. The device for data storing, according to claim 1, wherein the logically separated smallest areas (1) are the smallest areas of memory, which cannot be subdivided, and their multiplication, and their size depends upon the device for storing data.

9. The device for data storing, according to claim 1, wherein the logically separated smallest areas (1) have the size of 512 bits.

10. The device for data storing, according to claim 1, wherein the blocks (2, 3, 4) of predetermined size do not contain data concerning their state if they are completely busy or free and in that case related information is included in a greater block, with an integration level greater by one.

11. A method for dividing space for data storing with logically separated areas comprising the following step:
creating blocks of predetermined size from a defined number of logically separated smallest areas wherein smaller blocks are combined recurrently into greater blocks till the partition covers the entire area of a device for storing data, and wherein greater blocks with a higher level of combination are a definite multiplication of smaller blocks with a lower level of combination, and the smaller blocks are incorporated into the greater blocks greater by one level than the smaller blocks.

12. The method for dividing space, according to claim 11, wherein a block (3, 4) with greater, by one, integration level has a memory size equal to a multiple of a size of blocks (2, 3) with smaller, by one, integration level, and the amount of information that is stored in the logically separated smallest area (1).

13. The method for dividing space, according to claim 11, wherein a number of the logically separated smallest areas (1) in a block (2) of the minimal integration level is equal a number of bits that can be stored in the logically separated smallest area (1).

14. The method for dividing space, according to claim 11, wherein blocks (2, 3, 4) of predetermined size have at least three states and information concerning theirs state is stored within their area or within the area of blocks with greater, by one, integration level.

15. The method for dividing space, according to claim 11, wherein blocks (2, 3, 4) of predetermined size may be free, busy or fragmented.

16. The method for dividing space, according to claim 11, wherein the logically separated smallest areas (1) have at least two states.

17. The method for dividing space, according to claim 11, wherein the logically separated smallest areas (1) are either free or busy.

18. The method for dividing space, according to claim 11, wherein the logically separated smallest areas (1) are the smallest areas of memory, which cannot be subdivided, and their multiplication, and their size depends upon the device for storing data.

19. The method for dividing space, according to claim 11, wherein the logically separated smallest areas (1) have the size of 512 bits.

20. The method for dividing space, according to claim 11, wherein the blocks (2, 3, 4) of predetermined size do not contain data concerning their state if they are completely busy or free and in that case related information is included in a greater block, with an integration level greater by one.
